(19) United States
(12) Patent Application Publication
(10) Pub. No.: US 2023/0318086 A1
(43) Pub. Date: Oct. 5, 2023

(54) BATTERY MODULE AND BATTERY PACK INCLUDING THE SAME

(71) Applicant: LG ENERGY SOLUTION, LTD., Seoul (KR)

(72) Inventors: Tae Geun KIM, Daejeon (KR); Hyuk AN, Daejeon (KR); Sangwook YIM, Daejeon (KR); Jonghwa CHOI, Daejeon (KR); Hyoungsuk LEE, Daejeon (KR); YOUNG IL YOON, Daejeon (KR)

(73) Assignee: LG ENERGY SOLUTION, LTD., Seoul (KR)

(21) Appl. No.: 18/022,706

(22) PCT Filed: May 25, 2022
(86) PCT No.: PCT/KR2022/007399

§ 371 Date: Feb. 22, 2023

(30) Foreign Application Priority Data
Jun. 22, 2021 (KR) 10-2021-0080926

(51) Int. Cl. H01M 10/6566; H01M 10/6551; H01M 10/613; H01M 50/30; H01M 50/383

(52) U.S. Cl. CPC H01M 10/6566; H01M 10/6551; H01M 10/613; H01M 50/394; H01M 50/383

(57) ABSTRACT

A battery module includes a battery cell assembly in which a plurality of battery cells are stacked; a module frame that houses the upper and lower surface and both side surfaces of the battery cell assembly and is opened in its front and rear surfaces; a heat sink that is located on the module frame, but also includes a plurality of cooling flow paths; and a venting cover that is located on the heat sink, wherein the battery cell assembly includes a first battery cell assembly and a second battery cell assembly, and wherein the first battery cell assembly and the second battery cell assembly are arranged separately in a direction facing each other.

### TECHNICAL FIELD cl Cross Citation with Related Application(s)

This application claims the benefit of Korean Patent Application No. 10-2021-0080926 filed on Jun. 22, 2021 with the Korean Intellectual Property Office, the content of which is incorporated herein by reference in its entirety.

The present disclosure relates to a battery module and a battery pack including the same, and more particularly, to a battery module that enhances cooling performance and venting performance while increasing space efficiency, and a battery pack including the same.

### BACKGROUND

Along with the technology development and increased demand for mobile devices, the demand for batteries as energy sources is increasing rapidly. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

Small-sized mobile devices use one or several battery cells for each device, whereas middle or large-sized devices such as vehicles require high power and large capacity. Therefore, a middle or large-sized battery module having a plurality of battery cells electrically connected to one another is used.

The middle or large-sized battery module is preferably manufactured so as to have as small a size and weight as possible. Consequently, a prismatic battery, a pouch-shaped battery or the like, which can be stacked with high integration and has a small weight relative to capacity, is mainly used as a battery cell of the middle or large-sized battery module. Meanwhile, the battery module may include a module frame whose front and rear surfaces are opened to house the battery cell stack in the internal space, in order to protect the battery cell stack from external impact, heat or vibration.

Considering that the temperature of the battery cell is one of the factors that limit the output of the battery, the local temperature rise that occurs in the battery cell is highly likely to limit the output of the battery early, and thus it needs to be improved. In addition, recently, as the battery module has become larger in size, the number of battery cells stacked in the module has increased, the cooling deviation between the battery cells becomes more intense.

In addition, when a part of battery modules become an overvoltage, overcurrent or overheat state, the safety and operating efficiency of the battery module may be problematic. In particular, in order to improve the mileage, the battery module capacity tends to gradually increase, whereby it is necessary to design a structure that meets the strengthened safety standards and ensures the safety of vehicles and drivers. For this purpose, the necessity for a structure capable of effectively discharging gases and flames generated in a part of battery cells and thus minimizing the damage is uprising.

Therefore, there is a need to develop a battery module that can effectively discharge gases and/or flames generated when an ignition phenomenon occurs in some battery cells, while enhancing the cooling performance against the heat generated in the battery cell stack, and a battery pack including the same.

### DETAILED DESCRIPTION OF THE INVENTION

### Technical Problem

It is an object of the present disclosure to provide a battery module that enhances cooling performance and venting performance while increasing space efficiency, and a battery pack including the same.

The objects of the present disclosure are not limited to the aforementioned objects, and other objects which are not described herein should be clearly understood by those skilled in the art from the following detailed description and the accompanying drawings.

### Technical Solution

According to one aspect of the present disclosure, there is provided a battery module comprising: a battery cell assembly in which a plurality of battery cells are stacked; a module frame that houses the upper and lower surface and both side surfaces of the battery cell assembly and is opened in its front and rear surfaces; a heat sink that is located on the module frame, but also includes a plurality of cooling flow paths; and a venting cover that is located on the heat sink, wherein the battery cell assembly includes a first battery cell assembly and a second battery cell assembly, and wherein the first battery cell assembly and the second battery cell assembly are arranged separately in a direction facing each other.

The plurality of cooling flow paths protrude toward the venting cover with respect to the bottom surface of the heat sink, and a space between two cooling flow paths adjacent to each other among the plurality of cooling flow paths may form a venting flow path.

The venting cover protrudes toward a central part of the heat sink, but may also include a blocking part located on the venting flow path.

The plurality of cooling flow paths extend along the longitudinal direction of the heat sink, but may also be spaced apart from each other.

The upper part of the module frame may be formed with a cooling hole facing the upper surface of the battery cell assembly.

The cooling hole includes a first cooling hole and a second cooling hole, the first cooling hole faces an upper surface of the first battery cell assembly, and the second cooling hole may face an upper surface of the second battery cell assembly.

The battery module further comprises a heat transfer member located inside the cooling hole, wherein the heat transfer member may be located between the heat sink and the battery cell assembly.

The heat transfer member may be located between the heat sink and the upper surface of the first battery cell assembly and between the heat sink and the upper surface of the second battery cell assembly, respectively.

An upper part of the module frame may include at least one first venting hole formed between the first cooling hole and the second cooling hole.

A part of the at least one first venting hole is located adjacent to one surface of the first battery cell assembly, and the other part may be located adjacent to one surface of the second battery cell assembly.

The heat sink may be formed with at least one second venting hole at a position facing the at least one first venting hole.

The at least one second venting hole may be located between the first battery cell assembly and the second battery cell assembly, but is also located on the venting flow path.

The module frame includes a first U-shaped frame and a second U-shaped frame, the first U-shaped frame houses the upper surface and both side surfaces of the first battery cell assembly and the second battery cell assembly, and is opened in its front and rear surfaces, and the second U-shaped frame houses the bottom surface and both side surfaces of the first battery cell assembly and the second battery cell assembly, and may be opened in its front and rear surfaces.

The side surface of the first U-shaped frame includes a first extension part extending in outward direction, the side surface of the second U-shaped frame includes a second extension part extending in outward direction, and the first extension part and the second extension part may be in contact with each other.

The first extension part and the second extension part may be coupled to each other by a fixing member.

According to another aspect of the present disclosure, there is provided a battery pack comprising the above-mentioned battery module.

### Advantageous Effects

According to embodiments, the battery module of the present disclosure and a battery pack including the same can enhance cooling performance and venting performance while increasing space efficiency through a cooling flow path and a venting flow path formed by a heat sink and a venting cover located on the upper part of module frame.

The effects of the present disclosure are not limited to the effects mentioned above and additional other effects not described above will be clearly understood from the detailed description and the appended drawings by those skilled in the art.

### BRIEF DESCRIPTION OF THE DRAWINGS

FIG. 1 is an exploded perspective view of a battery module according to an embodiment of the present disclosure;

FIG. 2 is a perspective view of a battery module in which the components of FIG. 1 are combined;

FIG. 3 is a diagram schematically showing a cross section taken along the cutting line A-A of FIG. 2;

FIG. 4 is an enlarged view of a region a of FIG. 3; and

FIG. 5 is a diagram showing a cooling flow path and a venting flow path of FIG. 1.

### DETAILED DESCRIPTION OF THE EMBODIMENTS

Hereinafter, various embodiments of the present disclosure will be described in detail with reference to the accompanying drawings so that those skilled in the art can easily carry out them.

The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, areas, etc. are exaggerated for clarity. In the drawings, for convenience of description, the thicknesses of some layers and areas are exaggerated.

Further, throughout the description, when a portion is referred to as “including” a certain component, it means that the portion can further include other components, without excluding the other components, unless otherwise stated.

Further, throughout the description, when referred to as “planar”, it means when a target portion is viewed from the upper side, and when referred to as “cross-sectional”, it means when a target portion is viewed from the side of a cross section cut vertically.

Below, the battery module according to an embodiment of the present disclosure will be described. However, a description will be given on the basis of the front and rear surfaces of the battery module, but is not necessarily limited thereto. Even in the case of the rear surface, it will be described in the same or similar manner.

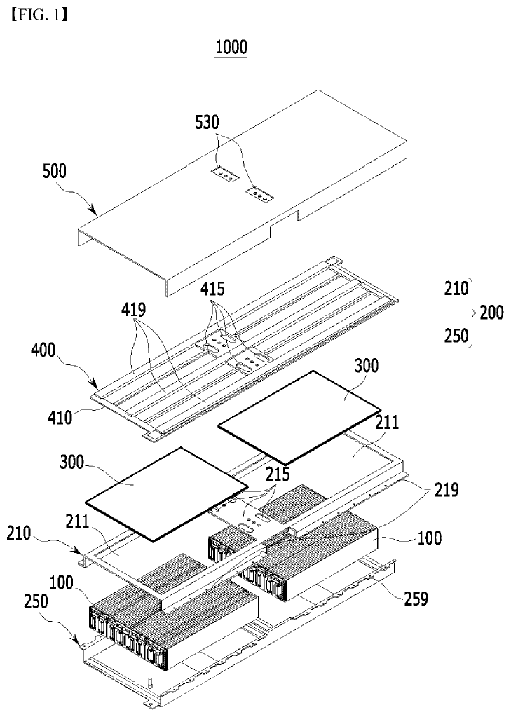

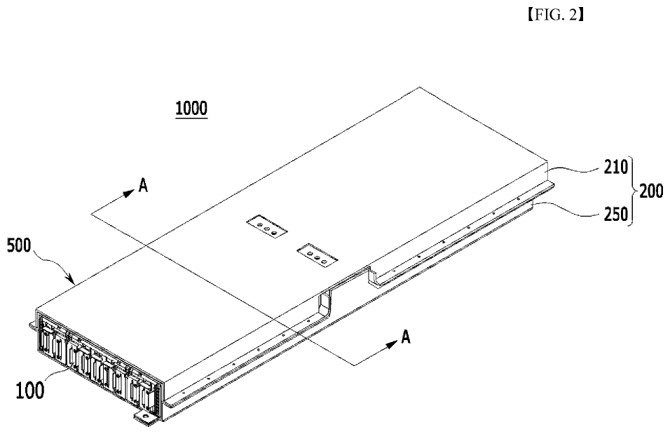

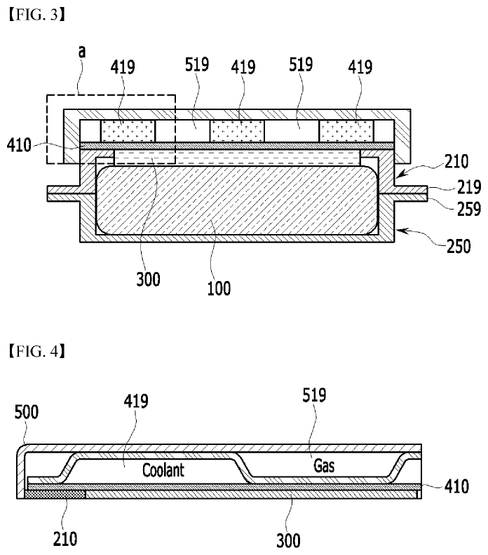

FIG. 1 is an exploded perspective view of a battery module according to an embodiment of the present disclosure. FIG. 2 is a perspective view of a battery module in which the components of FIG. 1 are combined. FIG. 3 is a diagram schematically showing a cross section taken along the cutting line A-A of FIG. 2.

Referring to FIGS. 1 to 3, a battery module 1000 according to an embodiment of the present disclosure includes a battery cell assembly 100 in which a plurality of battery cells are stacked; a module frame 200 that houses the upper and lower surface and both side surfaces of the battery cell assembly 100 and is opened in its front and rear surfaces; a heat sink 400 that is located on the module frame 200, but also includes a plurality of cooling flow paths 419; and a venting cover 500 that is located on the heat sink 400.

Wherein, the battery cell assembly 100 includes a first battery cell assembly and a second battery cell assembly. More specifically, the first battery cell assembly and the second battery cell assembly may be arranged separately in a direction facing each other. Wherein, the direction facing each other may be a direction in which the front or rear surface of the first battery cell assembly and the front or rear surface of the second battery cell assembly face each other. More preferably, the direction facing each other may be a direction in which the front surface of the first battery cell assembly and the front surface of the second battery cell assembly face each other, or may be a direction in which the rear surface of the first battery cell assembly and the rear surface of the second battery cell assembly face each other. However, the first battery cell assembly and the second battery cell assembly only differ depending on their positions and may be the same battery cell assembly as each other.

In addition, the battery cell assembly 100 may be formed by stacking a plurality of battery cells. Wherein, the battery cell is preferably a pouch-type battery cell. In one example, the battery cell can be manufactured by housing the electrode assembly in a pouch case of a laminated sheet containing a resin layer and a metal layer, and then heat-sealing a sealing part of the pouch case.

Further, such a battery cell can be formed in a rectangular sheet-like structure. Further, such a battery cell can be configured by a plurality of numbers, and the plurality of battery cells can be stacked so as to be electrically connected to each other, thereby forming a battery cell assembly 100.

Wherein, the battery module 200 may include a first U-shaped frame 210 and a second U-shaped frame 250. That is, the battery cell assembly 100 may be housed in the first U-shaped frame 210 and the second U-shaped frame 250. More specifically, the first U-shaped frame 210 may house the upper surface and both side surfaces of the first battery cell assembly and the second battery cell assembly, and may be opened in its upper surface and both side surfaces. Further, the second U-shaped frame 250 may house the bottom surface and both side surfaces of the first battery cell assembly and the second battery cell assembly, and may be opened in its front and rear surfaces.

Further, referring to FIGS. 1 and 3, a side surface of the first U-shaped frame 210 includes a first extension part 219 extending in outward direction, and a side surface of the second U-shaped frame 250 may include a second extension part 259 extending in outward direction. Wherein, the outward direction may be a direction opposite to the direction toward the battery cell assembly 100 with respect to the side surface of the module frame 200.

Wherein, the first extension part 219 and the second extension part 259 may be in contact with each other. In one example, the first extension part 219 and the second extension part 259 may be coupled to each other by a fixing member. Wherein, the fixing member may be a member such as a bolt or a nut. In another example, the first extension part 219 and the second extension part 259 may be coupled to each other by a method such as welding. However, the present disclosure is not limited thereto, and any fixing method capable of sealing the inside of the module frame 200 from the external environment can be included in the present embodiment.

In another example, the module frame 200 may include an upper plate instead of the first U-shaped frame 210. Thereby, the second U-shaped frame 250 houses the lower surface and both side surfaces of the battery cell assembly 100, and may be opened in its front and rear surfaces, and the upper plate may house the upper surface of the battery cell assembly 100. However, the present disclosure is not limited thereto, and the first U-shaped frame 210 and the second U-shaped frame 250 can be replaced with other shaped frames such as an L-shaped frame or a mono frame.

Further, although not shown in the figure, the module frame 200 may be formed with a separate partition wall between the first battery cell assembly and the second battery cell assembly. Thereby, the module frame 200 can protect the first battery cell assembly and the second battery cell assembly from external impacts and also can prevent heat transfer to other battery cell assemblies when an ignition phenomenon occurs in some battery cell assemblies.

Further, referring to FIGS. 1 and 3, the upper part of the module frame 200 may be formed with a cooling hole 211 facing the upper surface of the battery cell assembly 100. More specifically, the cooling hole 211 may include a first cooling hole and a second cooling hole. Wherein, the first cooling hole may face an upper surface of the first battery cell assembly, and the second cooling hole may face an upper surface of the second battery cell assembly.

More specifically, the cooling hole 211 may mean a hole that is opened toward the battery cell assembly 100 with respect to the upper surface of the module frame 200. In other words, in the upper surface of the module frame 200, the cooling hole 211 may be a region in which a part of the module frame 200 is removed so that a part of the upper surface of the battery cell assembly 100 is exposed.

Thereby, a part of the upper surface of the battery cell assembly 100 is opened by the cooling hole 211 in the upper part of the module frame 200, so that the heat sink 400 located on the upper part of the module frame 200 and the upper surface of the battery cell assembly 100 may be located adjacent to each other. That is, according to the present embodiment, a portion in which the module frame 200 is not formed may be formed between the heat sink 400 and the battery cell assembly 100, so that heat transfer between the heat sink 400 and the battery cell assembly 100 is efficient, and the cooling performance can be further enhanced.

Further, the module frame 200 may further include a heat transfer member 300 located inside the cooling hole 211, and the heat transfer member 300 may be located between the heat sink 400 and the battery cell assembly 200. Wherein, the heat transfer member 300 may extend along the length and width of the cooling hole 211.

More specifically, the heat transfer member 300 is located inside the first cooling hole, but may also be located between the heat sink 400 and the upper surface of the first battery cell assembly. Further, the heat transfer member 300 is located inside the second cooling hole, but may also be located between the heat sink 400 and the upper surface of the second battery cell assembly.

In one example, the heat transfer member 300 may be a thermally conductive resin layer formed by applying a thermally conductive resin. That is, the heat transfer member 300 may be formed as the thermally conductive resin previously applied to the inside of the cooling hole 211 is cured. In another example, the heat transfer member 300 may be a sheet or a pad made of a thermally conductive material. However, the present disclosure is not limited thereto, and any material and shape having thermal conductivity in which heat generated in the battery cell assembly 100 can be easily transferred to the heat sink 400 can be included in the present embodiment.

Therefore, in the present embodiment, the heat generated in the battery cell assembly 100 is transferred to the heat transfer member 300 making direct contact with the upper surface of the battery cell assembly 100 and is cooled by the heat sink 400 making contact with the heat transfer member 300, thereby capable of enhancing the cooling performance of the battery cell assembly 100. Further, the cooling deviation between the plurality of battery cells included in the battery cell assembly 100 can also be reduced, and the lifespan of the battery module 1000 can also be further improved.

Further, referring to FIGS. 1 and 3, the upper part of the module frame 200 may include at least one first venting hole 215 formed between the first cooling hole and the second cooling hole.

Wherein, a part of the at least one first venting hole 215 is located adjacent to one surface of the first battery cell assembly, and the other part may be located adjacent to one surface of the second battery cell assembly.

More specifically, the first venting hole 215 may mean a hole that is opened toward the inside of the module frame 200 with respect to the upper surface of the module frame 200. In other words, in the upper surface of the module frame 200, the first venting hole 215 may be a region in which a part of the module frame 200 is removed so that a part of the inside of the module frame 200 is exposed. In particular, the first venting hole 215 may be a hole that is opened toward a region located between one surface of the first battery cell assembly and one surface of the second battery cell assembly.

Thereby, the gas and/or flame generated when an ignition phenomenon occurs in the battery cell assembly 100 can be discharged to the outside through the at least one first venting hole 215, and the gas and flame discharged to the first venting hole 215 can be discharged to the outside through the venting flow path 519 formed between the heat sink 400 and the venting cover 500.

Further, although not shown in the figure, when a separate partition wall is formed between the first battery cell assembly and the second battery cell assembly in the module frame 200 as described above, at least one first venting hole 215 may be formed on both sides with the partition wall interposed therebetween. Thereby, the module frame 200 prevents heat transfer to other battery cell assemblies when an ignition phenomenon occurs in some battery cell assemblies, and also can easily discharge the generated flame and gas to the outside.

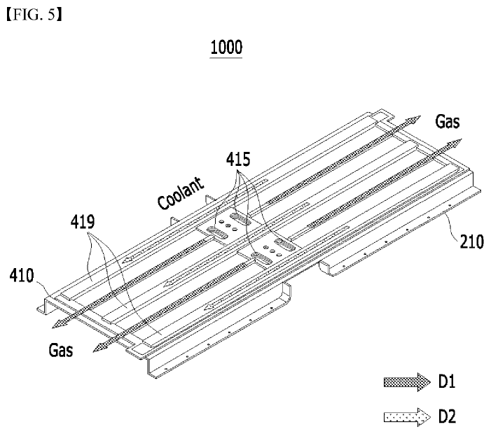

FIG. 4 is an enlarged view of a region a of FIG. 3.

Referring to FIGS. 1, 3, and 4, the heat sink 400 is located in the upper part of the module frame 200, but may also extend along the upper part of the module frame 200. In other words, the heat sink 400 may simultaneously contact the first battery cell assembly and the second battery cell assembly with the heat transfer member 300 interposed therebetween.

Further, the heat sink 400 may include a plurality of cooling flow paths 419 through which a coolant flows. More specifically, the plurality of cooling flow paths 419 may extend along the longitudinal direction of the heat sink 400, but may also be spaced apart from each other. Wherein, the cooling flow path 419 may protrude in a direction toward the venting cover 500 with respect to the bottom surface 410 of the heat sink 400.

Wherein, the cooling flow path 419 may include an outlet formed on one side of the heat sink 400 and an inlet formed on the opposite side of the heat sink 400. The outlet allows the coolant contained in the cooling flow path 419 to be discharged to the outside, and the inlet can supply a coolant into the cooling flow path 419.

Thereby, according to the present embodiment, the heat sink 400 can simultaneously cool the first battery cell assembly and the second battery cell assembly, thereby enhancing the cooling performance and space efficiency.

In another example, the cooling flow path 419 may include a first cooling flow path and a second cooling flow path, unlike FIG. 1, wherein the first cooling flow path may be located on the first battery cell assembly, and the second cooling flow path may be located on the second battery cell assembly. At this time, the inlet and outlet of the first cooling flow path are formed on one side of the heat sink 400, and the inlet and outlet of the second cooling flow path may be formed on the opposite side of the heat sink 400.

Thereby, in the heat sink 400, the cooling flow path 419 is divided with respect to the first battery cell assembly and the second battery cell assembly, and when an ignition phenomenon occurs in some battery cell assemblies, heat transfer to other battery cell assemblies can be prevented.

Further, referring to FIG. 1, the heat sink 400 may be formed with at least one second venting hole 415 at a position facing the at least one first venting hole 215. Wherein, at least one first venting hole 215 and at least one second venting hole 415 may be located between the first battery cell assembly and the second battery cell assembly.

More specifically, the second venting hole 415 may mean a hole that is opened toward the first venting hole 215 with respect to the bottom surface 410 of the heat sink 400. In other words, in the bottom surface 410 of the heat sink 400, the second venting hole 415 may be a region where a part of the heat sink 400 is removed so as to face the first venting hole 215.

Thereby, the gas and/or flame generated when an ignition phenomenon occurs in the battery cell assembly 100 is discharged through the at least one first venting hole 215, but the gas and/or flame flowed into the first venting hole 215 may also be discharged to the outside through the second venting hole 415.

Further, referring to FIGS. 1 to 4, the venting cover 500 is located on the heat sink 400, but may also extend along the upper part of the heat sink 400. In other words, the venting cover 500 may cover the upper part of the heat sink 400. In addition, based on the longitudinal direction of the heat sink 400, the venting cover 500 may extend along the side surface of the heat sink 400.

Further, referring to FIGS. 3 and 4, between the venting cover 500 and the heat sink 400, a venting flow path 519 is provided in a space between two cooling flow paths 419 adjacent to each other among the plurality of cooling flow paths 419. At this time, the upper part of the cooling flow path 419 may be in contact with the upper surface of the venting cover 500. That is, among the spaces separated between the venting cover 500 and the heat sink 400, a space in which the cooling flow path 419 is not formed may be the venting passage 519. In particular, the second venting hole 415 may be located between the first battery cell assembly and the second battery cell assembly, but may also be located on the venting flow path 519.

Thereby, the venting flow path 519 is formed through the space formed between cooling flow paths 419 without additional components, so that the space efficiency of the battery module 1000 can be further enhanced, and the manufacturing cost can also be reduced. Further, the gas and flame discharged to the second venting hole 415 can be discharged in a direction induced through the venting flow path 519 formed between the heat sink 400 and the venting cover 500, so that the venting performance of the battery module 1000 can also be enhanced.

Further, referring to FIGS. 1 and 2, the venting cover 500 protrudes toward a central part of the heat sink 400, but may also include a blocking part 530 located on the venting flow path 519. More specifically, the blocking part 530 may extend along between the venting cover 500 and the heat sink 400. In particular, the blocking part 530 may be located between a second venting hole 415 located adjacent to the first battery cell assembly and another second venting hole 415 located adjacent to the second battery cell assembly.

Thereby, in the venting cover 500, the venting flow path 519 is divided by the blocking part 530 with respect to the first battery cell assembly and the second battery cell assembly, and when an ignition phenomenon occurs in some battery cell assemblies, heat transfer to other battery cell assemblies can be prevented.

FIG. 5 is a diagram showing a cooling flow path and a venting flow path of FIG. 1.

Referring to FIGS. 1, 4 and 5, in the battery module 1000 according to the present embodiment, gas may move along the first direction D1 through the venting flow path 519 formed between the heat sink 400 and the venting cover 500. As mentioned above, the gas may be flowed into the venting flow path 519 through the first venting hole 215 and the second venting hole 415, and the gas flowed into the venting flow path 519 may be discharged by moving along the first direction D1 toward one side and/or the other side of the heat sink 400 due to a pressure difference.

In addition, the coolant flowing in the cooling passage 419 formed in the heat sink 400 can move along the second direction D2, and the heat generated in the battery cell assembly 100 can be cooled by the coolant flowing in the cooling flow path 419. Wherein, the second direction D2 may vary depending on the arrangement of the inlet and the outlet of the cooling flow path 419.

Thereby, the battery module 1000 according to the present embodiment can simultaneously form the cooling flow path 419 and the venting flow path 519 through the heat sink 400 and the venting cover 500, which is advantageous in enhancing both the cooling performance and the venting performance while increasing the space efficiency of the battery module 1000.

Meanwhile, one or more battery modules according to the present embodiment may be packaged in a pack case to form a battery pack.

The above-mentioned battery module and battery pack including the same can be applied to various devices. Such a device may be applied to a vehicle means such as an electric bicycle, an electric vehicle, or a hybrid vehicle, but the present disclosure is not limited thereto, and is applicable to various devices that can use a battery module and the battery pack including the same, which also falls under the scope of the present disclosure.

Although preferred embodiments of the present disclosure have been shown and described above, the scope of the present disclosure is not limited thereto, and numerous other variations and modifications can be made by those skilled in the art using the basic principles of the invention defined in the appended claims, which also falls within the spirit and scope of the invention.

### Description of Reference Numerals

100: battery cell assembly

200: module frame

210: first U-shaped frame

211: cooling hole

215: first venting hole

250: second U-shaped frame

300: heat transfer member

400: heat sink

415: second venting hole

419: cooling flow path

500: venting cover

519: venting flow path

1. A battery module comprising:
at least one battery cell assembly in which a plurality of battery cells are stacked;
a module frame that houses an upper surface, a lower surface and side surfaces of the at least one battery cell assembly and is opened in a front surface and a rear surface;
a heat sink that is located on the module frame, the heat sink including a plurality of cooling flow paths; and
a venting cover located on the heat sink,
wherein the at least one battery cell assembly includes a first battery cell assembly and a second battery cell assembly, and
wherein the first battery cell assembly and the second battery cell assembly are arranged separately in a direction facing each other.

2. The battery module according to claim 1 wherein:
the plurality of cooling flow paths protrude toward the venting cover with respect to a bottom surface of the heat sink, and
a space between two cooling flow paths adjacent to each other among the plurality of cooling flow paths forms a venting flow path.

3. The battery module according to claim 2 wherein:
the venting cover protrudes toward a central part of the heat sink, the venting cover including a blocking part located on the venting flow path.

4. The battery module according to claim 1 wherein:
the plurality of cooling flow paths extend along a longitudinal direction of the heat sink, the plurality of cooling flow paths being spaced apart from each other.

5. The battery module according to claim 2 wherein:
an upper part of the module frame is formed with a cooling hole facing the upper surface of the at least one battery cell assembly.

6. The battery module according to claim 5 wherein:
the cooling hole includes a first cooling hole and a second cooling hole, the first cooling hole facing an upper surface of the first battery cell assembly, and the second cooling hole facing an upper surface of the second battery cell assembly.

7. The battery module according to claim 5, further comprising a heat transfer member located inside the cooling hole,
wherein the heat transfer member is located between the heat sink and the at least one battery cell assembly.

8. The battery module according to claim 7 wherein:
the heat transfer member is located between the heat sink and an upper surface of the first battery cell assembly and between the heat sink and an upper surface of the second battery cell assembly, respectively.

9. The battery module according to claim 6 wherein:
the upper part of the module frame includes at least one first venting hole formed between the first cooling hole and the second cooling hole.

10. The battery module according to claim 9 wherein:
a first part of the at least one first venting hole is located adjacent to one surface of the first battery cell assembly, and a second part of the at least one first venting hole is located adjacent to one surface of the second battery cell assembly.

11. The battery module according to claim 9 wherein:
the heat sink is formed with at least one second venting hole at a position facing the at least one first venting hole.

12. The battery module according to claim 11 wherein:
the at least one second venting hole is located between the first battery cell assembly and the second battery cell assembly and on the venting flow path.

13. The battery module according to claim 1 wherein:
the module frame includes a first U-shaped frame and a second U-shaped frame,
the first U-shaped frame houses the upper surface and side surfaces of the first battery cell assembly and the second battery cell assembly, and is opened in a front surface and a rear surface, and
the second U-shaped frame houses the bottom surface and the side surfaces of the first battery cell assembly and the second battery cell assembly, and is opened in a front surface and a rear surface.

14. The battery module according to claim 13 wherein:
a side surface of the first U-shaped frame includes a first extension part extending in an outward direction,
a side surface of the second U-shaped frame includes a second extension part extending in the outward direction, and
the first extension part and the second extension part are in contact with each other.

15. The battery module according to claim 14 wherein:
the first extension part and the second extension part are coupled to each other by a fixing member.

16. A battery pack comprising the battery module according to claim 1.
